(19) United States
(12) Patent Application Publication
(10) Pub. No.: US 2019/0061057 A1
(43) Pub. Date: Feb. 28, 2019

(54) METHOD FOR PRODUCING A WORK PIECE THROUGH GENERATIVE MANUFACTURING, AND CORRESPONDING WORK PIECE

(71) Applicant: SIEMENS AKTIENGESELLSCHAFT, München (DE)

(72) Inventors: Christian Brunhuber, Auerbach (DE); Stefan Denneler, München (DE); Moritz Fischle, München (DE); Henning Hanebuth, Pliening OT Gelting (DE); Steffen Walter, Oberpframmern (DE)

(73) Assignee: Siemens Aktiengesellschaft, Munich (DE)

(21) Appl. No.: 15/766,913

(22) PCT Filed: Sep. 27, 2016
(86) PCT No.: PCT/EP2016/072894

§ 371 Date: Apr. 9, 2018

(30) Foreign Application Priority Data
Oct. 14, 2015 (EP) 15189765.9

(51) Int. Cl. B23K 26/342; B23K 15/00; B23K 26/60; B33Y 10/00; B33Y 80/00; B33Y 70/00

(52) U.S. Cl. CPC B23K 26/342; B23K 15/0033; B23K 15/0086; B23K 2101/001; B33Y 10/00; B33Y 80/00; B33Y 70/00; B23K 26/60

(57) ABSTRACT

A method for producing a work piece includes the providing of a substrate having a predetermined surface structure and the generative manufacturing of a material for the work piece on the surface structure, such that the surface structure defines a base surface of the work piece to be manufactured, wherein the generative manufacturing is carried out by deposition welding and wherein the base surface is an at least partially interior surface of the work piece in respect of a contour of the work piece that is to be manufactured. The method furthermore includes the detaching of the substrate.

### CROSS REFERENCE TO RELATED APPLICATIONS

This application is the US National Stage of International Application No. PCT/EP2016/072894 filed Sep. 27, 2016, and claims the benefit thereof. The International Application claims the benefit of European Application No. EP15189765 filed Oct. 14, 2015. All of the applications are incorporated by reference herein in their entirety.

### FIELD OF INVENTION

The present invention relates to a method for producing a workpiece, for example a high-temperature-resistant workpiece, such as a workpiece or component, which is used in the hot gas path of a fluid-flow machine, for example a gas turbine. The present invention also relates to a workpiece which has been or can be produced by said method.

### BACKGROUND OF INVENTION

Additive or generative manufacturing methods (“rapid prototyping”) for producing three-dimensional (3D) structures, such as, for example, selective laser melting (SLM), and deposition welding, for example laser cladding (or LMD for “laser metal deposition”), are used, for example, during the production and also during the repair of parts of gas turbines that are subjected to hot gas or high temperature. The SLM method permits the generative construction of complex moldings or workpieces with a relatively fine internal structure, for example with finenesses or structure sizes between 80 μm and 100 μm or less.

The SLM method belongs to powder bed methods, wherein a reduction in the size of the structure sizes or an improvement in the surface roughness can primarily be achieved by reducing the size of the powder fractions down to an average powder grain size of about 20-40 μm. Still finer powder grains can generally no longer be conveyed and/or applied. An achievable surface roughness of surfaces produced by means of SLM methods lies approximately between 60 μm and 100 μm. The SLM method also permits construction rates or deposition rates of 3-8 cm³/h.

As opposed to the aforementioned deposition welding or LMD methods, the SLM process either permits the construction of a structure along only one axis and/or it is necessary to fall back on supporting structures which, for example, permit the overhanging or hollow structures to be fabricated to be supported during the production and, if appropriate, for a necessary dissipation of heat. However, these supporting structures need unnecessary deposition material and, moreover, subsequently have to be separated from the actually desired structure in a complicated manner, or appropriately re-worked.

On the other hand, in the LMD process, the generative or additive construction can be carried out along at least three axes (for example three mutually perpendicular spatial directions). In the LMD method, alternatively five-axis or eight-axis devices can be used, in which, for example, a base or substructure for the material to be constructed, and also a deposition or production head or the appropriate powder nozzle or laser device is movable in three mutually perpendicular spatial directions. For an eight-axis device, that is to say having eight geometric degrees of freedom, the substructure can additionally be movable about two different axes (rotation and/or tilted axes).

The LMD method is usually a CAD (“computer aided design”) and/or robot-assisted method, wherein 3D structures can be built up or produced quasi isotropically. As opposed to the SLM method, here, during the construction of the structure or the workpiece, it is likewise possible to “switch” to and fro between multiple materials. The LMD method permits construction or deposition rates of 30 to 40 cm³/h. One disadvantage of the LMD method relates to the difficulty of producing internal structures or interior structures or geometries with structure sizes or structure dimensions of less than 150 μm, which means that limits are placed on additive fabrication in this regard.

In particular during the production of components for fluid-flow machines, for example gas turbines, internal structures with structure sizes of, to some extent, considerably below 100 μm or 150 μm are desired or required for a large number of possible components for different applications. Such structures are currently producible only by means of time-consuming and costly casting technology.

Deposition welding methods are, for example known from EP 2 756 909 A1.

### SUMMARY OF INVENTION

It is therefore an object of the present invention to specify an improved method for producing a workpiece or a component, in particular a method with which components can be produced more cost-efficiently and/or time-efficiently, or components with improved properties can be produced.

This object is achieved by the features of the independent patent claims. Advantageous refinements are the subject matter of the dependent patent claims.

One aspect of the present invention relates to a method for producing a workpiece comprising providing a substrate having a predetermined surface structure. The workpiece is advantageously a high-temperature-resistant component for use in the hot gas path of a fluid-flow machine, for example a gas turbine for power generation.

The predetermined surface structure is advantageously a microscopic surface structure. In other words, the predetermined surface structure advantageously has at least one microscopic surface structure element. The surface structure is also predetermined, i.e. for example defined with respect to its topography or structure for a specific application.

The method also comprises the generative manufacturing of a material for the workpiece or component on the predetermined surface structure, so that the surface structure defines a base surface of the workpiece to be produced, wherein the generative manufacturing is carried out by means of deposition welding, and wherein the base surface is an at least partly interior surface of the workpiece with respect to a contour of the workpiece to be produced.

The generative manufacturing or the generative fabrication in the present case advantageously means the primary shaping or additive construction of 3D workpieces or components.

The base surface is advantageously the surface of an underside of the workpiece, the structure of which is advantageously constructed or deposited first during the production. In this sense, the substrate is advantageously formative for the workpiece or the component, wherein the structure of the substrate can be transferred to the base surface of the workpiece to be produced or imaged on the same by the method according to the invention. In this sense, the base surface of the workpiece can, for example, have or form a negative or positive of the predetermined surface structure. The surface structure advantageously forms the corresponding negative or represents the latter, and the base surface forms the corresponding positive or represents the latter. The base surface further advantageously represents an impression of the surface structure of the substrate, defines the latter or comprises the aforementioned impression. In this connection, the workpiece according to the present disclosure can likewise have an (imaged) surface structure.

The method also comprises the detachment of the substrate after the generative manufacturing, for example by means of an acid treatment or further methods from the prior art.

The method described can comprise further method steps, for example a temperature treatment after the generative manufacturing of the material, wherein in particular a crystal structure or material phase that is beneficial or required for the workpiece is in particular established. In the process, crystal defects in the material can be healed and/or internal stresses in the material can be reduced.

As an advantage of the method described, it is possible, according to the present invention, to produce internal structures on the base surface or corresponding dimensions of the internal structures which, for example, cannot be achieved solely via conventional LMD technology, i.e. without the definition according to the invention of the base surface. This is achieved in particular by the fact that, by means of the method described, the predetermined surface structure defines the base surface for the workpiece to be produced by the LMD method via the substrate.

Following the provision of the substrate with the predetermined surface structure, any desired 3D workpiece or component can then be produced in any desired way, for example by means of deposition welding, with the base surface defined by the surface structure. In particular, it is possible to dispense with the time-consuming production of casting cores or cast components by conventional casting technology, wherein, during the molding of complex, microscopic internal structures, a development lasting for months (for example 6 months) often has to be incurred. Conversely, the aforementioned advantages of the LMD process can be utilized.

In one refinement, the generative manufacturing is carried out by means of laser cladding, in particular laser powder deposition welding. According to this refinement, the method for the generative manufacturing is advantageously a deposition welding method.

In one refinement, during the generative manufacturing of the material for the workpiece, in particular by laser deposition welding, the exposure time, the laser power and/or further parameters are set in accordance with the desired surface structure of the workpiece. Here, for example, the grain orientation or grain size of the material to be constructed for the workpiece can be adjusted or influenced, which means, for example, that the creep strength of the material or the crack resistance or ductility can be optimized. Alternatively or additionally, by means of the aforementioned refinement, bonding defects, for example with respect to cohesion or adhesion of the materials involved, can be prevented.

The internal surface can be an inwardly directed or internally arranged surface of the workpiece. In other words, the base surface is advantageously at least partly located within or on the aforementioned contour. In this sense, the contour advantageously describes an enveloping surface of the workpiece or component.

In one refinement, the provision of the substrate is carried out in such a way that the surface structure for the definition of the base surface has at least one surface structure element, advantageously a multiplicity of surface structure elements, having a dimension of (respectively) less than 100 μm.

In one refinement, the provision of the substrate is carried out in such a way that the surface structure for the definition of the base surface has at least one surface structure element, advantageously a multiplicity of surface structure elements, having a dimension of (respectively) less than 80 μm.

The inventive advantage of the method described relates to improved “resolution” of structures or features on the base surface and/or increased fabrication accuracy. Furthermore, it is possible to dispense with complicated supporting structures.

It is in particular possible to produce microstructures having individual structure sizes of less than 100 μm, for example on the inner side of components or workpieces which are difficult to access, which cannot be achieved either with powder bed methods, for example SLM technology, or with milling technology—lack of accessibility of the milling tool to the aforementioned inner side because of the size of the milling heads.

In one refinement, the material for the workpiece is a nickel-based or cobalt-based superalloy or a starting material therefor.

In one refinement, the material for the workpiece comprises a nickel-based or cobalt-based superalloy or a starting material therefor.

These refinements are in particular expedient for use of the workpiece or component in the area of fluid-flow machines.

In one refinement, the workpiece is a high-temperature-resistant component, for example a component which is used in or in conjunction with the hot air or hot gas path of a fluid-flow machine, such as a gas turbine. High-temperature-resistant can in particular mean that the workpiece or component or its material is highly heat-resistant, has a melting point of more than 1000° C., advantageously 1200° C., and/or for example reaches operating temperatures of 80%, 90% or more of the melting point of the corresponding material.

In one refinement, the provision of the substrate is carried out in such a way that the substrate comprises a ceramic or a cast component which forms the surface structure. Expressed in concrete terms, the substrate can comprise the ceramic or the cast component. The component can, for example, be produced or provided by precision casting.

In one refinement, the provision is carried out in such a way that the surface structure comprises a refractory metal or high melting-point metal as main constituent.

According to this refinement, the surface structure is produced, advantageously by appropriate construction of the substrate, by electron-beam melting. Electron-beam melting, as a powder bed method, permits in particular—in a way analogous to the SLM method—the additive fabrication of 3D structures, i.e. not just quasi-two-dimensional layer structures. Here, still higher temperatures—for melting the material or metal—are achieved by the electron beam. According to this refinement, it is advantageously also possible to dispense with a ceramic as substrate. In particular, the production of the surface structure by means of electron beam welding also permits provision of the surface structure that is simplified and accelerated as compared with a casting core. However, according to this refinement, under certain circumstances not quite such small or intricate internal structures are achievable as with the aid of casting technology. In any case, with respect to the structure sizes, this refinement permits the production of smaller or more intricate surface structures as compared with workpieces which have been produced solely by means of LMD technology.

According to one refinement, the surface structure is produced, advantageously by appropriate construction of the substrate, by selective laser melting, for example with aluminum or copper as main constituent. The advantages of this refinement are comparable with those which have been described in the previous refinement. Achieved in particular are an improvement in the production method of the workpiece by avoiding ceramic cast components or casting cores, and/or a higher geometric resolution of surface structure elements.

In one refinement, the generative manufacturing is carried out by means of laser powder deposition welding wherein, during the generative manufacturing, a powder focus—of a corresponding device—is established between the surface structure and a laser focus. This refinement advantageously corresponds to that in which a ceramic component is used as substrate and/or wherein the surface structure is produced or provided by selective laser welding. As an advantage, it is possible to avoid the surface structure burning or melting during the generative manufacturing by irradiation with the laser beam.

A further aspect of the present invention relates to a workpiece or component which has been or can be produced by the method described here, for example a workpiece comprising the base surface, wherein the production method for the workpiece comprises the generative manufacturing of the material for the workpiece on the predetermined surface structure of the substrate, wherein the surface structure defines the base surface. In other words, the base surface comprises an impression of the surface structure or part of the surface structure. The base surface can likewise represent an impression of the predetermined surface structure or a part thereof.

According to the described production method, the workpiece described advantageously has specific and/or characteristic properties. For example, the material or workpiece can be distinguished with regard to its structure or surface properties by means of relevant methods of surface or structural analysis of workpieces which have been or can be produced by means of other methods. Such methods are, for example, transmission electron microscopy (TEM), energy-dispersive x-ray analysis and/or x-ray fluorescence analysis. By means of these methods, in particular the crystal structure of the corresponding material can be examined and an elemental analysis can be carried out.

Features which refer to the method in the present case can likewise refer to the workpiece or the component, and vice versa.

Further details of the invention will be described below by using the drawing. Identical or mutually corresponding drawing elements are each provided with the same designations in the individual figures.

### BRIEF DESCRIPTION OF THE DRAWINGS

FIG. 1 shows, schematically, the sequence of a method for producing a workpiece.

FIG. 2 shows, schematically, a workpiece which has been produced by means of the method shown in FIG. 1.

FIG. 3 shows, schematically, the adjustment of part of a device for deposition welding according to the method described.

### DETAILED DESCRIPTION OF INVENTION

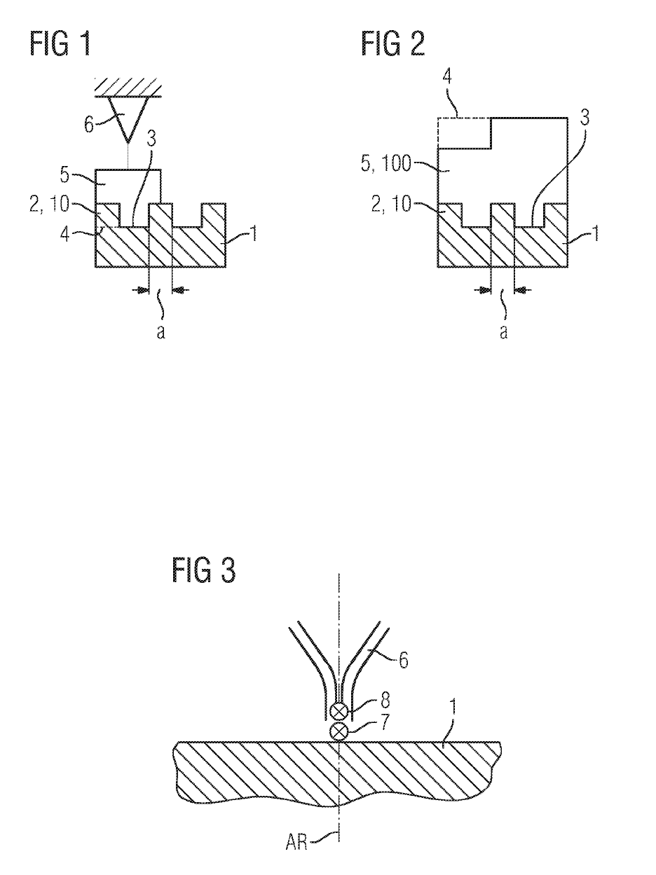

FIG. 1 shows, schematically, the sequence of a method for producing a workpiece or component (cf. designation 100 in FIG. 2), for example a component for a fluid-flow machine such as a gas turbine. The workpiece 100 is advantageously a high-temperature-resistant workpiece used in conjunction with a hot air path of a gas turbine. The workpiece or component is advantageously composed of a nickel-based or cobalt-based superalloy or comprises a corresponding material.

The method comprises providing a substrate 1, which in FIG. 1 and FIG. 2 is illustrated in a side or sectional view. The substrate 1 comprises a predetermined surface structure 2. The predetermined surface structure 2 is advantageously a surface structure having surface structure elements 10, as indicated in FIGS. 1 and 2. The surface structure elements 10 each have a rectangular cross section. The surface structure elements 10 are advantageously microscopically small. In other words, the surface structure elements 10, advantageously each individual or at least one of the surface structure elements 10, has an external dimension in the micrometer range, advantageously less than 100 μm, particularly advantageously less than 80 μm or even smaller (cf. dimension a described further below). The surface structure 2 is advantageously predetermined or defined for the production of the workpiece. In other words, the topography of the surface structure is defined.

Although this is not illustrated explicitly in the figures, the surface structure elements or else only some of them can be different and/or have dimensions differing from one another.

The method also comprises the generative manufacturing of a material 5 for the workpiece on the surface structure 2, so that the surface structure 2 defines a base surface 3 of the workpiece to be produced. This is indicated in FIG. 1 by the fact that the surface structure 2 forms a negative and the base surface 3 or the surface structure of the latter (not explicitly identified) forms a corresponding positive. In other words, the surface structure 2 of the substrate 1 is formative for the base surface of the workpiece 100. The deposited material and/or the finished workpiece (cf. FIG. 2) accordingly have the base surface 3.

In FIG. 1, the workpiece has not yet been finally produced (cf. designation 100 in the figure). In the following, the material 5 can therefore be designated synonymously with the workpiece 100. The material can in particular be a starting material for the workpiece.

Furthermore, the method for producing the workpiece can comprise one or more heat treatments, for example for establishing specific phase precipitations. This can involve, in particular, expedient phase precipitations or settings of the y or y′ phases of the respective material of the superalloy to be produced.

The generative manufacturing is advantageously carried out by means of deposition welding, for example laser cladding (LMD), in particular laser powder deposition welding. The aforementioned methods or techniques of deposition welding are advantageously executed with CAD and/or robot assistance or can be controlled appropriately. A corresponding laser cladding device is indicated by the designation 6 in FIG. 1.

The material 5 for producing the workpiece 100 is advantageously fabricated or produced in accordance with the method described by laser powder deposition welding. Here, within the context of the method described for producing the workpiece, the latter is advantageously fabricated in accordance with the material properties that are expedient for the desired (3D) structure. Process parameters such as the laser power, the exposure time of the laser or further parameters can be set in accordance with the desired material phase. Furthermore, for example at points or edges of the workpiece to be produced that are difficult to access, a longer exposure time may be necessary than at other points. In addition, during “scanning” during the material construction, an apparatus head of the deposition welding device can be guided by or with the aid of a feedback loop.

FIG. 2 shows, inter alia, the finally produced workpiece or component 100 which has been or can be produced by means of the method described. The workpiece 100 is still connected in one piece to the substrate 1. Accordingly, the base surface 3 of the substrate constitutes an impression of the surface structure 2 or comprises the same. Advantageously, by means of the method described, by means of the pre-definition of the surface structure on the substrate, the base surface of the workpiece to be produced is defined, imaged or molded, in order to transfer the surface structure to the workpiece and thus to produce a particularly high-resolution and/or microscopically structured base surface of the workpiece.

The workpiece 100 in FIG. 2 has a contour 4 which encloses or envelops the workpiece 100, including the surface structure elements of the latter. The contour 4 is illustrated by the dashed line in FIG. 2 and, in conjunction with the material 5, also in FIG. 1. The base surface 3 is, with respect to the contour 4 of the workpiece 100 to be produced, an at least partly interior surface of the workpiece 100.

The surface structure elements 10 shown in FIGS. 1 and 2, or at least one of them, advantageously has/have a dimension a of less than 100 μm. The dimension advantageously refers to a width (cf. horizontal direction in FIGS. 1 and 2) of the respective surface structure elements 10 and not to a corresponding depth or height. Accordingly, the width can designate a direction along the contour.

Therefore, the smaller the width or the dimension a of the surface structure elements 10 of the substrate 1, the smaller, finer or more intricately is the base surface 3 of the workpiece also structured.

Particularly advantageously, at least one of the aforementioned surface structure elements 10 or all of the same can have an external dimension a of less than 80 μm or even less.

According to one embodiment of the present invention, the substrate 1 is a ceramic or a cast component or comprises, for example, a ceramic, at least on the surface structure 2. The substrate 1 can be produced or provided, for example, by precision casting with the aid of ceramic casting cores. Advantageously, the surface structure 2 is formed by a ceramic casting core. The casting core consists, for example, of aluminum oxide, for example Al₂O₃, or silicon dioxide (SiO₂) or comprises one of these materials. In other words, the provision can be carried out appropriately in accordance with the method described.

Furthermore, the casting core advantageously has very fine powder granulation on the outside, in order expediently to be able to “resolve” a fine, for example microscopically small, surface structure. With increasing distance from the surface structure, the material of said substrate (of the casting core) can comprise a granulation or graduation becoming more and more porous or coarser, in order at the same time still to have an adequate (thermal) shock resistance. Such a graduated component advantageously has a particularly small and technologically desired surface roughness of only 50 μm or less, for example 30 μm. The aforementioned roughness can be an average roughness, a quadratic roughness or a median roughness.

According to one refinement, the substrate comprises a refractory metal, for example tantalum, zirconium, molybdenum or tungsten or another high melting-point, for example non-precious, metal of the fourth, fifth or the sixth secondary group of the periodic table, at least on or as the surface structure 2. According to this refinement, the surface structure is advantageously produced by electron beam melting.

According to a further refinement, the surface structure 2 is produced by selective laser melting. According to this refinement, the surface structure 2 of the substrate 1 advantageously has copper or aluminum as main constituent. Alternatively, the substrate 1 can consist of other materials or comprise said materials.

Although this is not explicitly illustrated in the figures, the method also comprises the detachment of the substrate 1 after the generative manufacturing. The substrate can be detached selectively in chemical ways for all the embodiments described. For example, irrespective of whether the substrate or the surface structure is metallic or ceramic, the workpiece can be detached chemically. For example, in the case of a substrate having an aluminum surface structure, the detachment can be carried out by means of concentrated nitric acid and at temperatures between 50° C. and 80° C.

FIG. 3 shows, schematically, the adjustment of part of a device for deposition welding according to one refinement of the method. This refinement relates in particular to the generative manufacturing by means of laser powder deposition welding. Accordingly, a laser cladding device 6 is indicated. In addition, according to this refinement, the surface structure 2 of the substrate 1, as described above, is advantageously formed from a ceramic or by means of selective laser melting from a metal, or comprising the latter.

It can be seen in particular in FIG. 3 that the laser cladding device 6 has a powder focus 7. The laser cladding device 6 also has a laser focus 8. The powder focus 7 is/has been established in the vertical direction, for example along a construction direction AR of the workpiece 100, between the substrate 1 and a laser focus 8. As a result, it is then advantageously possible to avoid the surface structure which, according to this refinement, is advantageously formed by a ceramic or a non high-melting-point metal, melting or burning as a result of the influence of the laser beam.

The invention is not restricted to the exemplary embodiments by the description using the same but in particular comprises any combination of features in the patent claims, even if this feature or this combination is not itself explicitly specified in the patent claims or exemplary embodiments.

1.-10. (canceled)

11. A method for producing a workpiece for use in a hot gas path of a fluid-flow machine, comprising:
providing a substrate having a predetermined surface structure,
generative manufacturing of a material for the workpiece on the surface structure, so that the surface structure defines a base surface of the workpiece to be produced, wherein the generative manufacturing is carried out by deposition welding, wherein the base surface is an at least partially interior surface of the workpiece with respect to a contour of the workpiece that is to be manufactured, and wherein the provision is carried out in such a way that the surface structure for the definition of the base surface has at least one surface structure element with a dimension of less than 100 μm, and
detaching the substrate.

12. The method as claimed in claim 11,
wherein the material is a nickel-based or cobalt-based superalloy or a starting material therefor.

13. The method as claimed in claim 11,
wherein the workpiece is a high-temperature-resistant component.

14. The method as claimed in claim 11,
wherein the provision is carried out in such a way that the substrate comprises a ceramic which forms the surface structure.

15. The method as claimed in claim 11,
wherein the provision is carried out in such a way that the surface structure comprises a refractory metal as main constituent.

16. The method as claimed in claim 15,
wherein the surface structure is produced by electron beam melting.

17. The method as claimed in claim 11,
wherein the provision is carried out in such a way that the surface structure is produced by selective laser melting.

18. The method as claimed in claim 11,
wherein the generative manufacturing is carried out by means of laser powder deposition welding, and
wherein, during the generative manufacturing, a powder focus is established between the surface structure and a laser focus.

19. A workpiece for use in a hot gas path of a fluid-flow machine, which is produced in accordance with the method as claimed in claim 11, the workpiece comprising:
a base surface which is an at least partially interior surface with respect to a contour of the workpiece, and
wherein the surface structure for the definition of the base surface has at least one surface structure element with a dimension of less than 100 μm.

20. The method as claimed in claim 17,
wherein the provision is carried out in such a way that the surface structure is produced by selective laser melting with aluminum or copper as a main constituent.
